(19) United States
(12) Patent Application Publication
(10) Pub. No.: US 2007/0084320 A1
(43) Pub. Date: Apr. 19, 2007

(54) Cutting tool with very fine adjustment

(75) Inventors: Peter Frank, Seligenthal (DE); Jens Neumann, Wernshausen (DE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB

(21) Appl. No.: 11/526,246

(22) Filed: Sep. 25, 2006

(30) Foreign Application Priority Data
Sep. 23, 2005 (DE) 10 2005 045 752.5

(51) Int. Cl. B23B 29/00

(52) U.S. Cl. 82/158

(57) ABSTRACT

A cutting tool including a main tool body and a tool carrier which is movable relative thereto for accommodating a cutting bit. The tool carrier has a screwthreaded bore co-operating with a first screwthread on a drive shaft in such a way that the tool carrier can be moved relative to the main tool body by rotation of the drive shaft. The drive shaft has a second screwthread which is arranged in a screwthreaded bore in the main tool body, such that the two screwthreads differ in respect of their pitch and/or direction of rotation.

This application claims priority under 35 U.S.C. § 119 to German Patent Application No. 10 2005 045 752.5, filed on Sep. 23, 2005, the disclosure of which is incorporated by reference herein in its entirety.

### FIELD OF THE INVENTION

The present invention relates generally to a cutting tool including a main tool body and a tool carrier which is movable relative thereto for accommodating a cutting bit, wherein the tool carrier has a screwthreaded bore co-operating with a screwthread on a drive shaft in such a way that the tool carrier can be moved relative to the main tool body by rotation of the drive shaft.

### BACKGROUND OF THE INVENTION

Cutting tools of the type described above have long been known. For example, a boring-out tool is known which has a main tool body, at the end of which there is provided a tool carrier which is adjustable relative to the main tool body, the tool carrier being movable in the radial direction. Here the tool carrier comes into engagement with a drive shaft mounted in the main tool body, by way of a screwthread, so that the tool carrier can be reciprocated in the radial direction by rotation of the drive shaft. As the tool carrier in use carries a suitable cutting bit, the boring radius of the boring-out tool can be adjusted by means of the drive shaft.

For many situations of use, there is a desire to provide for a highly accurate setting of the tool carrier relative to the main tool body. In the case of the known cutting tools, the screwthread of the drive shaft and the corresponding screwthread on the main tool body are frequently in the form of fine screwthreads.

However, fine screwthreads are correspondingly more expensive to produce, in proportion to their respective fineness. In addition, pitches of more than 0.25 mm per revolution are usual. Finer screwthreads can scarcely be produced in practice and are to be implemented at all only with a high level of complication and expenditure.

For many situations of use therefore, the provision of a fine screwthread with a pitch of only 0.25 mm per revolution is still too coarse to easily ensure precise setting of the tool carrier relative to the main tool body.

Therefore, based on that state of the art, an object of the invention is to provide a cutting tool whose tool carrier can be very precisely adjusted relative to the main tool body and which in addition is inexpensive to manufacture.

### SUMMARY OF THE INVENTION

In accordance with an embodiment of the invention, an object is attained in that the drive shaft has a second screwthread which co-operates with a corresponding screwthread in the main tool body, wherein the two screwthreads of the drive shaft differ in respect of their pitch and/or direction of rotation.

By virtue of such an arrangement, rotation of the drive shaft involves a translatory movement of the drive shaft with respect to the main tool body. The relative movement of the tool carrier with respect to the main tool body is therefore determined by the addition of the relative movements between the tool carrier and the drive shaft, on the one hand, and between the drive shaft and the main tool body, on the other hand. If, for example, the first screwthread of the drive shaft has a pitch of 0.35 mm per revolution and the second screwthread has a pitch of 0.5 mm per revolution, then, with the same direction of rotation of the two screwthreads, the effective relative movement of the tool carrier with respect to the main tool body is 0.15 mm (0.5-0.35) per revolution. The reason for this is that the drive shaft moves relative to the main body by 0.5 mm per revolution; the tool carrier however moves relative to the drive shaft by 0.35 mm per revolution in the opposite direction.

Although the two screwthreads are not of the finest possible configuration, nonetheless a markedly finer adjustable positioning of the tool carrier relative to the main tool body is achieved.

The first screwthread and/or the second screwthread advantageously has a pitch of between 0.15 mm and 0.5 mm per revolution, wherein the relative movement between the main tool body and the tool carrier is established with the same rotational movement by the difference between the two pitches.

In principle, the screwthreads on the drive shaft can be in the form of female or male screwthreads. It has been found however that an embodiment in which the tool carrier has a slider sleeve, wherein the slider sleeve is accommodated in a bore in the main tool body and has a female screwthread which is in engagement with the first screwthread of the drive shaft is simpler to manufacture. In other words, the first screwthread of the drive shaft is advantageously a male screwthread.

A rotation-preventing means may be provided to prevent rotation of the slider sleeve within the bore in the main tool body. For that purpose, the bore could have, for example, a rib-shaped projection which extends axially with respect to the axis of the bore and which enters a corresponding groove in the slider sleeve.

In a further embodiment, the drive shaft has a polygonal socket, preferably a hexagonal socket, for rotating the drive shaft about its axis.

Furthermore in another embodiment, it is provided that the drive shaft has a spindle element and the main tool body has a guide surface, wherein the spindle element has at least two recesses and the guide surface has a projection which upon suitable setting of the spindle element engages into a recess and thereby establishes a position. In that case the spindle element is fixedly connected to the drive shaft so that rotation of the drive shaft causes rotation of the spindle element. An exact position for the drive shaft in relation to the main tool body can be established by the recesses. The drive shaft is moved together with the spindle element until the projection of the guide surface of the main tool body latches into the recess in the spindle element. The recess and the projection are advantageously of such a configuration that upon manual actuation of the drive shaft, latching engagement is noticed, that is to say “felt.”

It will be appreciated that recesses and projection can also exchange their positions so that the recesses are provided in the guide surface while the spindle element has a corresponding projection.

In another embodiment, the projection is formed by a resiliently biased pressure portion.

It has further been found that the spindle element may include a spindle wheel, at the outer edge of which are provided a plurality of grooves forming the recesses.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a view from below of a boring-out head in accordance with an embodiment of the invention;

FIG. 2 is a side view of the boring-out tool of FIG. 1;

FIG. 3 is a section taken along line A-A in FIG. 1;

FIG. 4 is a sectional view along line B-B in FIG. 3; and

FIG. 5 is a view on an enlarged scale of a portion of FIG. 4.

### DETAILED DESCRIPTION OF THE PREFERRED EMBODIMENTS

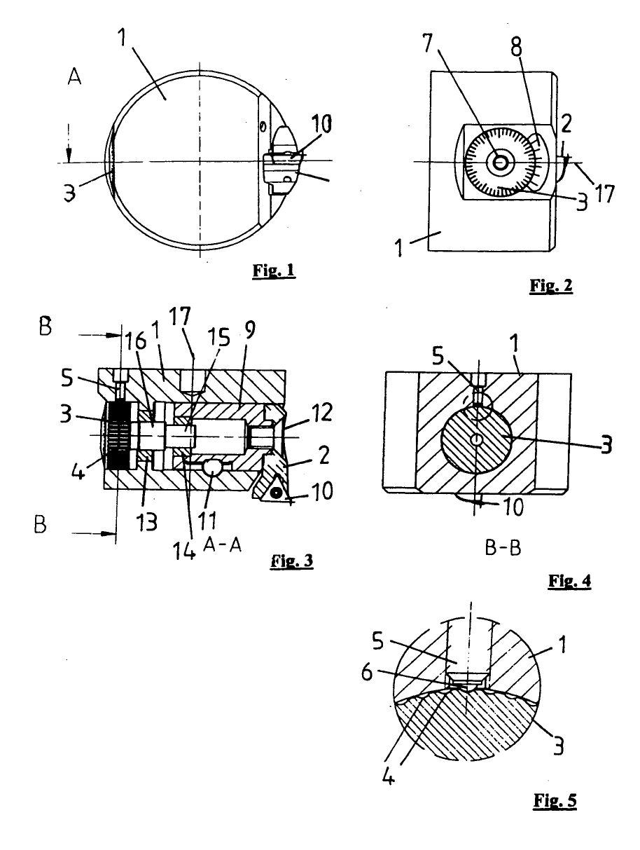

FIG. 1 shows a boring-out head from below. The boring-out head has a main tool body 1 which here is of a substantially cylindrical configuration. The boring-out head rotates about a cylinder axis 17 in operation. Fixed to the main tool body 1 is a tool carrier carrying a cutting bit 10 which in operation is in engagement with the workpiece to be machined. A spindle element 3 which is in the form of a spindle wheel can also be seen from FIG. 1. The tool carrier 2 can be adjusted in a radial direction, that is to say towards the left or the right in FIG. 1, relative to the main tool body 1.

FIG. 2 is a partial side view of the boring-out tool of FIG. 1, and shows the main tool body 1, a part of the tool carrier 2 and the spindle wheel 3. The rotary axis 17 extends perpendicularly to the axis of the spindle wheel 3. The spindle wheel 3 has a hexagonal socket, by means of which the spindle wheel 3 can be moved with the drive shaft (not shown in FIG. 2) in order to adjust the tool carrier 2 in a radial direction. The spindle wheel 3 has a main scale 7 which co-operates with a corresponding vernier scale 8 on the tool carrier. The scales serve for precise setting of the tool carrier 2 relative to the main tool body 1.

FIG. 3 is a view in section along line A-A in FIG. 1, and shows the cutting bit 10 provided with the tool carrier 2. More precisely the tool carrier 2 here is of a two-part configuration and includes the part 2 holding the cutting bit 10 and a slider sleeve 9. The part 2 holding the cutting bit 10 is fixed to the slider sleeve 9 by means of a fixing screw 12. The slider sleeve 9 is accommodated in a bore in the main tool body 1. A rotation-preventing means 11 is provided to prevent rotation of the slider sleeve 9 within the bore in the main body 1.

The slider sleeve 9 also has a bush 14 with a female screwthread. In the same manner, a bush 13 within the main tool body 1 is also provided with a female screwthread. The spindle wheel 3 is connected to a drive shaft 15, 16 which here includes two portions of different outside diameters 15, 16. The portion 15 of the drive shaft has a male screwthread which comes into engagement with the female screwthread in the bush 14. Similarly, the portion 16 of the drive shaft has a male screwthread which comes into engagement with the female screwthread of the bush 13.

The drive shaft 15, 16 has two different screwthreads which differ in respect of their pitch and/or their direction of rotation. If, for example, the spindle wheel 3 is rotated in the clockwise direction, the entire drive shaft 15, 16 moves from left to right, that is to say into the tool, by virtue of the engagement with the female screwthread of the bush 13. As at the same time the slider sleeve 9 is connected to the drive shaft by way of the screwthread between the bush 14 and the portion 15 of the drive shaft, the slider sleeve 9 moves relative to the drive shaft 15, 16 towards the left, that is to say into the tool. If, for example, the screwthread on the bush 13 of the main tool body 1 has a pitch of 0.3 mm per revolution and the screwthread on the bush 14 of the slider sleeve 9 has a pitch of 0.25 mm per revolution, then a full revolution of the spindle wheel 3 or the drive shaft 15, 16 causes a relative movement between the slider sleeve 9 and the main body 1 by only 0.05 mm.

As illustrated in FIGS. 4 and 5, the spindle wheel 3 has a series of grooves 4 at its outer periphery. Also arranged in the main tool body 1 is a resilient pressure portion 5 which comes into engagement with the grooves 4 in the spindle wheel 3. FIG. 4 is a view in section along line B-B in FIG. 3. The spindle 3 with the external grooving and the resilient pressure portion 5 can be seen therein.

FIG. 5 shows a detail on an enlarged scale. The resilient pressure portion 5 which is oriented radially with respect to the axis of the spindle element has a resiliently biased ball 6 which engages into the grooves 4 in the spindle element 3. When the spindle wheel 3 is moved the resiliently biased ball successively engages into the corresponding grooves 4 so that, upon manual adjustment of the spindle wheel 3, there is a correspondingly perceptible resistance so that the tool carrier 2 and therewith the cutting bit 10 can be specifically displaced by a given distance in a radial direction, by for example, the spindle wheel 3 being rotated through a given number of “clicks,” that is to say a given number of recesses.

The cutting bit can be highly accurately adjusted by virtue of the configuration of the drive shaft according to the invention.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

What is claimed is:

1. A cutting tool comprising a main tool body and a tool carrier which is movable relative to the main tool body for accommodating a cutting bit, wherein the tool carrier has a screwthreaded bore co-operating with a first screwthread on a drive shaft such that the tool carrier can be moved relative to the main tool body by rotation of the drive shaft, wherein the drive shaft has a second screwthread which is arranged in a screwthreaded bore in the main tool body, wherein the two screwthreads differ in respect of their pitch and/or direction of rotation.

2. The cutting tool according to claim 1, wherein the first screwthread has a pitch of between 0.15 and 0.5 mm per revolution.

3. The cutting tool according to claim 1, wherein the second screwthread has a pitch of between 0.15 and 0.5 mm per revolution.

4. The cutting tool according to claim 1, wherein the tool carrier has a slider sleeve, wherein the slider sleeve is accommodated in a bore in the main tool body and has a female screwthread which is in engagement with the first screwthread of the drive shaft.

5. The cutting tool according to claim 4, further comprising a rotation-preventing means which prevents rotation of the slider sleeve within the bore in the main tool body.

6. The cutting tool according to claim 1, wherein the drive shaft has a polygonal socket for rotation of the drive shaft about its shaft axis.

7. The cutting tool according to claim 1, wherein the drive shaft has a spindle element and the main tool body has a guide surface, wherein the spindle element has at least two recesses and the guide surface has a projection which upon suitable setting of the spindle element engages into a recess and thereby establishes a position.

8. The cutting tool according to claim 1, wherein the drive shaft has a spindle element and the main tool body has a guide surface, wherein the guide surface has at least two recesses and the spindle element has a projection which upon suitable setting of the spindle element engages into a recess and thereby establishes a position.

9. The cutting tool according to claim 7, wherein the projection is formed by a resiliently biased pressure portion.

10. The cutting tool according to claim 7, wherein the spindle element comprises a spindle wheel, at the outer edge of which are provided a plurality of grooves forming the recesses.

11. The cutting tool according to claim 2, wherein the second screwthread has a pitch of between 0.15 and 0.5 mm per revolution.

12. The cutting tool according to claim 1, wherein the polygonal socket is a hexagonal socket.

13. A cutting tool comprising:
a main tool body having a screwthreaded bore;
a tool carrier having a screwthreaded bore, the tool carrier being adapted to accommodate a cutting bit; and
a drive shaft including a first screwthread co-operating with the screwthreaded bore of the tool carrier, and a second screwthread co-operating with the screwthreaded bore of the main tool body, the first screwthread having a first pitch and a first direction of rotation, the second screwthread having a second pitch and a second direction of rotation, and the tool carrier being movable relative to the main tool body by rotation of the drive shaft.
